(19) United States
(12) Patent Application Publication
(10) Pub. No.: US 2017/0149749 A1
(43) Pub. Date: May 25, 2017

(54) EXCHANGING ENCRYPTED MEDIA OVER A LOCAL WIRELESS CONNECTION IN ACCORDANCE WITH A LOCAL WIRELESS RENDERED MEDIA DISTRIBUTION SCHEME

(71) Applicant: QUALCOMM Incorporated, San Diego, CA (US)

(72) Inventors: Khosro Mohammad RABII, San Diego, CA (US); Vijay Naicker SUBRAMANIAM, San Diego, CA (US); Padam Lal KAFLE, San Diego, CA (US); Fawad SHAUKAT, San Diego, CA (US); Tyler TURNER, San Diego, CA (US); Shivakumar BALASUBRAMANYAM, San Diego, CA (US)

(21) Appl. No.: 14/947,043

(22) Filed: Nov. 20, 2015

(51) Int. Cl. H04L 29/06; H04L 9/08; H04W 12/06

(52) U.S. Cl. CPC H04L 63/0442; H04W 12/06; H04L 63/168; H04L 63/164; H04L 9/0822

(57) ABSTRACT

In an embodiment, a media source transmits, to media presentation device(s) over a local wireless connection, media, a first key for decrypting the media and a second key for decrypting the first key. The second key is transmitted via a unicast protocol and is encrypted is based upon a point-to-point security framework (e.g., IPSec). The media presentation device(s) each decrypt the first key using the second key, and then decrypt the media using the decrypted first key. The media presentation device(s) then present at least a portion of the decrypted media.

### BACKGROUND

### 1. Field of the Invention

Embodiments relate to exchanging encrypted media over a local wireless connection in accordance with a local wireless rendered media distribution scheme.

### 2. Description of the Related Art

Various protocols exist for streaming media (e.g., video, audio, etc.) over local wireless networks (e.g., infrastructure Wireless Local Area Networks (WLANs), etc.). One example of is Miracast, which defines a protocol by which a Source Device (e.g., a UE such as a phone, laptop, etc.) can connect to an external display device (referred to as a Sink) using a WiFi Direct connection.

Security frameworks in Version R1 of Miracast (hereinafter, “Miracast-R1”) include WiFi-Security (e.g., WiFi Protected Setup (WPS), Wired Equivalent Privacy (WEP) and/or WiFi Protected Access (WPA), etc.) and High-Bandwidth Digital Content Protection (HDCP). Miracast-R2 is a newer version of Miracast that is currently under development and which is considering support for one-to-many transmission schemes. However, for various reasons, it may be difficult to deploy the security frameworks available in Miracast-R1 to one-to-many transmission schemes (e.g., multicast or broadcast) such as those contemplated for Miracast-R2.

For example, in Miracast-R1, the basic unit of media distribution is a Moving Picture Experts Group (MPEG)-Transport Stream (TS) packet. In Miracast-R1, each MPEG-TS packet is 188 bytes long that carries 184 bytes of payload data. Security frameworks such a WPS, WEP, WPA, Internet Protocol Security (IPsec) and HDCP are not possible to apply in Miracast-R1 to the level of MPEG2-TS packets for conditional access of media streams belonging to different program identifiers (PIDs). For example, in Mircast-R1, WiFi-Security (e.g., WPS, WEP, WPA, etc.) is used for protecting Media Access Control (MAC) Service Data Units (MSDUs), IPSec is used for protecting IP packets and HDCP is used for protecting the media-data in the packetized elementary stream (PES) packet.

In terms of security, certain WiFi-Security protocols (e.g., WEP and 802.11i security manager) maintain session keys within a WiFi subsystem, and it is forbidden to expose or share security parameters (e.g., keys, contexts, etc.) outside of an associated security domain.

Further, the above-noted security frameworks (e.g., WPS, WEP, WPA, IPSec, HDCP, etc.) conventionally use pairwise security association. This is useful for one-to-one packet transfer, but pairwise security associations can be difficult to extend to one-to-many scenarios (e.g., broadcast or multicast). For example, a given Source device (e.g. a UE) that wants to transmit to N target Sink devices would need to establish a unique pairwise security association with each of the N target Sink devices, resulting in N total pairwise security associations. Hence, it is difficult to scale security frameworks that use pairwise security association for one-to-many media distribution schemes (e.g., multi-channel audio, multi-screen video, etc.).

Further, HDCP uses Digital Visual Interface (DVI) stream cipher. DVI stream cipher typically requires significant processing resources & power. Considering WiFi channel latency and packet-drop rates, deployment of DVI stream cipher may cause link termination which in turn requires lengthy link re-establishments. Also, DVI stream cipher is generally designed for XOR RGB pixel-data with PN-data, and is not typically used on MPEG-TS packets' level.

### SUMMARY

An aspect is directed to a media source configured to exchange rendered media over a local wireless connection in accordance with a local wireless media distribution scheme. The media source transmits rendered media that is encrypted in accordance with a first encryption scheme to one or more media presentation devices via a given protocol over a local wireless connection. The media source transmits a first key for decrypting the first encryption scheme to the one or more media presentation devices over the local wireless connection, the first key being encrypted in accordance with a second encryption scheme. The media source transmits a second key for decrypting the second encryption scheme separately to each of the one or more media presentation devices via a unicast protocol over the local wireless connection, the second key being encrypted in accordance with a third encryption scheme that is based upon a point-to-point security framework.

Another aspect is directed to a media presentation device configured to exchange rendered media over a local wireless connection in accordance with a local wireless media distribution scheme. The media presentation device receives rendered media that is encrypted in accordance with a first encryption scheme via a given protocol over a local wireless connection. The media presentation device receives a first key for decrypting the first encryption scheme over the local wireless connection, the first key being encrypted in accordance with a second encryption scheme. The media presentation device receives a second key for decrypting the second encryption scheme to each of the one or more media presentation devices via a unicast protocol over the local wireless connection, the second key being encrypted in accordance with a third encryption scheme that is based upon a point-to-point security framework. The media presentation device decrypts the second key using the point-to-point security framework, the first key using the decrypted second key, and the rendered media using the decrypted first key. The media presentation device presents at least a portion of the decrypted rendered media.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 illustrates a high-level system architecture of a wireless communications system in accordance with an embodiment of the invention.

FIG. 2 illustrates examples of user equipments (UEs) in accordance with embodiments of the invention.

FIG. 3 illustrates a communication device that includes logic configured to perform functionality in accordance with an embodiment of the invention.

FIG. 4 illustrates a server in accordance with an embodiment of the invention.

FIG. 5 illustrates a conventional UE configuration.

FIG. 6 illustrates a WiFi display source that is configured to send media to a WiFi display sink via a WiFi-Miracast link using conventional security protocols.

FIG. 7 illustrates a process of distributing rendered media over a local wireless connection in accordance with an embodiment of the invention.

FIG. 8 illustrates a conference room including various devices in accordance with an embodiment of the invention.

FIG. 9 illustrates operation of a given media presentation device during the process of FIG. 7 in accordance with an embodiment of the invention.

FIG. 10 illustrates the processes of FIGS. 7 and 9 being performed in unison in accordance with an embodiment of the invention.

FIG. 11 illustrates an example of a Miracast-based system in accordance with an embodiment of the invention.

FIGS. 12-13 illustrate an example implementation of the processes of FIGS. 7 and 9 in the Miracast-based system of FIG. 11 in accordance with an embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

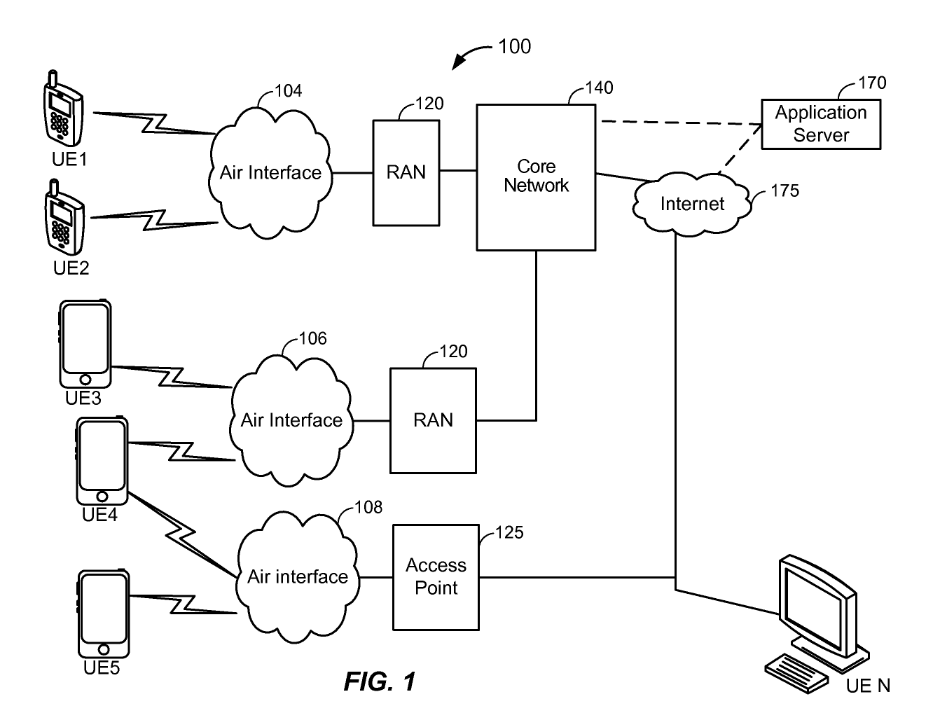

FIG. 1 illustrates a high-level system architecture of a wireless communications system 100 in accordance with an embodiment of the invention. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UEs 1 . . . N via the core network 140. Also shown in FIG.1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, a server 170 is shown as connected to the Internet 175, the core network 140, or both. The server 170 can be implemented as a plurality of structurally separate servers, or alternately may correspond to a single server. As will be described below in more detail, the server 170 is configured to support one or more communication services (e.g., Voice-over-Internet Protocol (VoIP) sessions, Push-to-Talk (PTT) sessions, group communication sessions, social networking services, etc.) for UEs that can connect to the server 170 via the core network 140 and/or the Internet 175, and/or to provide content (e.g., web page downloads) to the UEs.

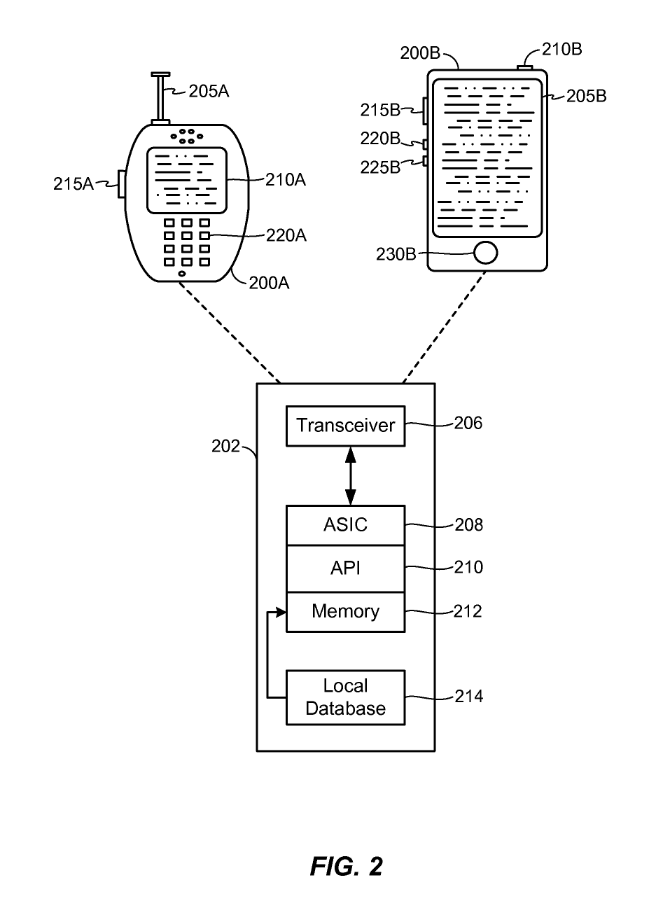

FIG. 2 illustrates examples of UEs (i.e., client devices) in accordance with embodiments of the invention. Referring to FIG. 2, UE 200A is illustrated as a calling telephone and UE 200B is illustrated as a touchscreen device (e.g., a smart phone, a tablet computer, etc.). As shown in FIG. 2, an external casing of UE 200A is configured with an antenna 205A, display 210A, at least one button 215A (e.g., a PTT button, a power button, a volume control button, etc.) and a keypad 220A among other components, as is known in the art. Also, an external casing of UE 200B is configured with a touchscreen display 205B, peripheral buttons 210B, 215B, 220B and 225B (e.g., a power control button, a volume or vibrate control button, an airplane mode toggle button, etc.), at least one front-panel button 230B (e.g., a Home button, etc.), among other components, as is known in the art. While not shown explicitly as part of UE 200B, the UE 200B can include one or more external antennas and/or one or more integrated antennas that are built into the external casing of UE 200B, including but not limited to WiFi antennas, cellular antennas, satellite position system (SPS) antennas (e.g., global positioning system (GPS) antennas), and so on.

While internal components of UEs such as the UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., application server 170, web URLs, etc.). The platform 202 can also independently execute locally stored applications without RAN interaction. The platform 202 can include a transceiver 206 operably coupled to an application specific integrated circuit (ASIC) 208, or other processor, microprocessor, logic circuit, or other data processing device. The ASIC 208 or other processor executes the application programming interface (API) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can store applications not actively used in memory 212, as well as other data. The local database 214 is typically a flash memory cell, but can be any secondary storage device as known in the art, such as magnetic media, EEPROM, optical media, tape, soft or hard disk, or the like.

Accordingly, an embodiment of the invention can include a UE (e.g., UE 200A, 200B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UEs 200A and 200B in FIG. 2 are to be considered merely illustrative and the invention is not limited to the illustrated features or arrangement.

The wireless communication between the UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

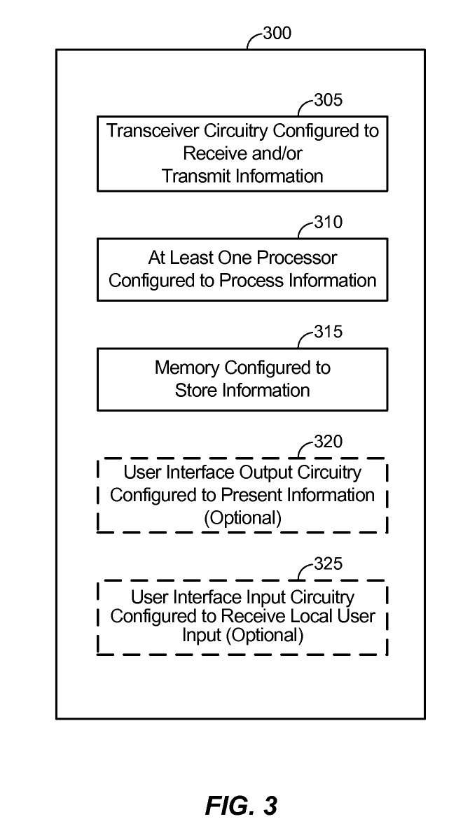

FIG. 3 illustrates a communication device 300 that includes structural components to perform functionality. The communication device 300 can correspond to any of the above-noted communication devices, including but not limited to UEs 1 . . . N, UEs 200A and 200B, any component included in the RAN 120 such as base stations, access points or eNodeBs, any component of the core network 140, an components coupled to the Internet 175 (e.g., the application server 170), and so on. Thus, communication device 300 can correspond to any electronic device that is configured to communicate with (or facilitate communication with) one or more other entities over the wireless communications systems 100 of FIG. 1.

Referring to FIG. 3, the communication device 300 includes transceiver circuitry configured to receive and/or transmit information 305. In an example, if the communication device 300 corresponds to a wireless communications device (e.g., UE 200A or UE 200B), the transceiver circuitry configured to receive and/or transmit information 305 can include a wireless communications interface (e.g., Bluetooth, WiFi, WiFi Direct, Long-Term Evolution (LTE) Direct, etc.) such as a wireless transceiver and associated hardware (e.g., an RF antenna, a MODEM, a modulator and/or demodulator, etc.). In another example, the transceiver circuitry configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., the application server 170), the transceiver circuitry configured to receive and/or transmit information 305 can correspond to an Ethernet card, in an example, that connects the network-based server to other communication entities via an Ethernet protocol. In a further example, the transceiver circuitry configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The transceiver circuitry configured to receive and/or transmit information 305 can also include software that, when executed, permits the associated hardware of the transceiver circuitry configured to receive and/or transmit information 305 to perform its reception and/or transmission function(s). However, the transceiver circuitry configured to receive and/or transmit information 305 does not correspond to software alone, and the transceiver circuitry configured to receive and/or transmit information 305 relies at least in part upon structural hardware to achieve its functionality. Moreover, the transceiver circuitry configured to receive and/or transmit information 305 may be implicated by language other than “receive” and “transmit”, so long as the underlying function corresponds to a receive or transmit function. For an example, functions such as obtaining, acquiring, retrieving, measuring, etc., may be performed by the transceiver circuitry configured to receive and/or transmit information 305 in certain contexts as being specific types of receive functions. In another example, functions such as sending, delivering, conveying, forwarding, etc., may be performed by the transceiver circuitry configured to receive and/or transmit information 305 in certain contexts as being specific types of transmit functions. Other functions that correspond to other types of receive and/or transmit functions may also be performed by the transceiver circuitry configured to receive and/or transmit information 305.

Referring to FIG. 3, the communication device 300 further includes at least one processor configured to process information 310. Example implementations of the type of processing that can be performed by the at least one processor configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the at least one processor configured to process information 310 can include a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the at least one processor configured to process information 310 may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The at least one processor configured to process information 310 can also include software that, when executed, permits the associated hardware of the at least one processor configured to process information 310 to perform its processing function(s). However, the at least one processor configured to process information 310 does not correspond to software alone, and the at least one processor configured to process information 310 relies at least in part upon structural hardware to achieve its functionality. Moreover, the at least one processor configured to process information 310 may be implicated by language other than “processing”, so long as the underlying function corresponds to a processing function. For an example, functions such as evaluating, determining, calculating, identifying, etc., may be performed by the at least one processor configured to process information 310 in certain contexts as being specific types of processing functions. Other functions that correspond to other types of processing functions may also be performed by the at least one processor configured to process information 310.

Referring to FIG. 3, the communication device 300 further includes memory configured to store information 315. In an example, the memory configured to store information 315 can include at least a non-transitory memory and associated hardware (e.g., a memory controller, etc.). For example, the non-transitory memory included in the memory configured to store information 315 can correspond to RAM, flash memory, ROM, erasable programmable ROM (EPROM), EEPROM, registers, hard disk, a removable disk, a CD-ROM, or any other form of storage medium known in the art. The memory configured to store information 315 can also include software that, when executed, permits the associated hardware of the memory configured to store information 315 to perform its storage function(s). However, the memory configured to store information 315 does not correspond to software alone, and the memory configured to store information 315 relies at least in part upon structural hardware to achieve its functionality. Moreover, the memory configured to store information 315 may be implicated by language other than “storing”, so long as the underlying function corresponds to a storing function. For an example, functions such as caching, maintaining, etc., may be performed by the memory configured to store information 315 in certain contexts as being specific types of storing functions. Other functions that correspond to other types of storing functions may also be performed by the memory configured to store information 315.

Referring to FIG. 3, the communication device 300 further optionally includes user interface output circuitry configured to present information 320. In an example, the user interface output circuitry configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to the UE 200A and/or UE 200B as shown in FIG. 2, the user interface output circuitry configured to present information 320 can include the display 226. In a further example, the user interface output circuitry configured to present information 320 can be omitted for certain communication devices, such as network communication devices that do not have a local user (e.g., network switches or routers, remote servers, etc.). The user interface output circuitry configured to present information 320 can also include software that, when executed, permits the associated hardware of the user interface output circuitry configured to present information 320 to perform its presentation function(s). However, the user interface output circuitry configured to present information 320 does not correspond to software alone, and the user interface output circuitry configured to present information 320 relies at least in part upon structural hardware to achieve its functionality. Moreover, the user interface output circuitry configured to present information 320 may be implicated by language other than “presenting”, so long as the underlying function corresponds to a presenting function. For an example, functions such as displaying, outputting, prompting, conveying, etc., may be performed by the user interface output circuitry configured to present information 320 in certain contexts as being specific types of presenting functions. Other functions that correspond to other types of storing functions may also be performed by the user interface output circuitry configured to present information 320.

Referring to FIG. 3, the communication device 300 further optionally includes user interface input circuitry configured to receive local user input 325. In an example, the user interface input circuitry configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to UE 200A or UE 200B as shown in FIG. 2, the user interface input circuitry configured to receive local user input 325 can include the buttons 220A, the display 210A (if a touchscreen), etc. In a further example, the user interface input circuitry configured to receive local user input 325 can be omitted for certain communication devices, such as network communication devices that do not have a local user (e.g., network switches or routers, remote servers, etc.). The user interface input circuitry configured to receive local user input 325 can also include software that, when executed, permits the associated hardware of the user interface input circuitry configured to receive local user input 325 to perform its input reception function(s). However, the user interface input circuitry configured to receive local user input 325 does not correspond to software alone, and the user interface input circuitry configured to receive local user input 325 relies at least in part upon structural hardware to achieve its functionality. Moreover, the user interface input circuitry configured to receive local user input 325 may be implicated by language other than “receiving local user input”, so long as the underlying function corresponds to a receiving local user function. For an example, functions such as obtaining, receiving, collecting, etc., may be performed by the user interface input circuitry configured to receive local user input 325 in certain contexts as being specific types of receiving local user functions. Other functions that correspond to other types of receiving local user input functions may also be performed by the user interface input circuitry configured to receive local user input 325.

Referring to FIG. 3, while the configured structural components of 305 through 325 are shown as separate or distinct blocks in FIG. 3 that are implicitly coupled to each other via an associated communication bus (not shown expressly), it will be appreciated that the hardware and/or software by which the respective configured structural components of 305 through 325 performs their respective functionality can overlap in part. For example, any software used to facilitate the functionality of the configured structural components of 305 through 325 can be stored in the non-transitory memory associated with the memory configured to store information 315, such that the configured structural components of 305 through 325 each performs their respective functionality (i.e., in this case, software execution) based in part upon the operation of software stored by the memory configured to store information 315. Likewise, hardware that is directly associated with one of the configured structural components of 305 through 325 can be borrowed or used by other of the configured structural components of 305 through 325 from time to time. For example, the at least one processor configured to process information 310 can format data into an appropriate format before being transmitted by the transceiver circuitry configured to receive and/or transmit information 305, such that the transceiver circuitry configured to receive and/or transmit information 305 performs its functionality (i.e., in this case, transmission of data) based in part upon the operation of structural hardware associated with the at least one processor configured to process information 310.

Accordingly, the various structural components of 305 through 325 are intended to invoke an aspect that is at least partially implemented with structural hardware, and are not intended to map to software-only implementations that are independent of hardware and/or to non-structural functional interpretations. Other interactions or cooperation between the structural components of 305 through in the various blocks will become clear to one of ordinary skill in the art from a review of the aspects described below in more detail.

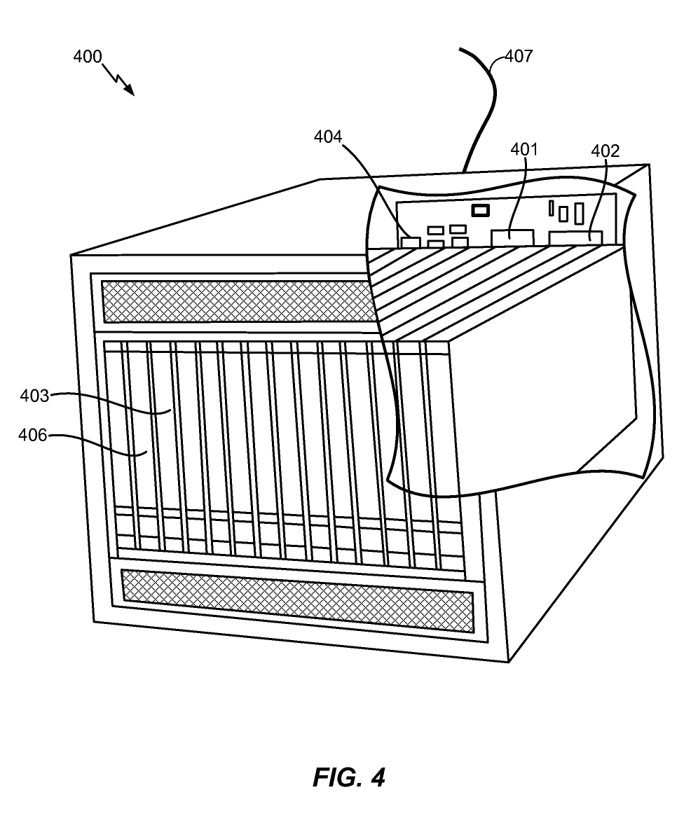

The various embodiments may be implemented on any of a variety of commercially available server devices, such as server 400 illustrated in FIG. 4. In an example, the server 400 may correspond to one example configuration of the application server 170 described above. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communication device 300, whereby the transceiver circuitry configured to transmit and/or receive information 305 corresponds to the network access points 404 used by the server 400 to communicate with the network 407, the at least one processor configured to process information 310 corresponds to the processor 401, and the memory configuration to store information 315 corresponds to any combination of the volatile memory 402, the disk drive 403 and/or the disc drive 406. The optional user interface output circuitry configured to present information 320 and the optional user interface input circuitry configured to receive local user input 325 are not shown explicitly in FIG. 4 and may or may not be included therein. Thus, FIG. 4 helps to demonstrate that the communication device 300 may be implemented as a server, in addition to a UE as in FIG. 2.

Various protocols exist for streaming media (e.g., video, audio, etc.) over local wireless networks (e.g., infrastructure Wireless Local Area Networks (WLANs), etc.). One example of it is Miracast, which defines a protocol by which a Source device (such as an UE) can connect to an external display device (referred as a Sink device) using a WiFi Direct connection.

Security frameworks in Version R1 of Miracast (hereinafter, “Miracast-R1”) include WiFi-Security (e.g., WiFi Protected Setup (WPS), Wired Equivalent Privacy (WEP) and/or WiFi Protected Access (WPA), etc.), Internet Protocol Security (IPsec) and High-Bandwidth Digital Content Protection (HDCP). Miracast-R2 is a newer version of Miracast that is currently under development and which is considering support for one-to-many transmission schemes. However, for various reasons, it may be difficult to deploy the security frameworks available in Miracast-R1 to one-to-many transmission schemes (e.g., multicast or broadcast) such as those contemplated for Miracast-R2.

For example, in Miracast-R1, the basic unit of media distribution is a Moving Picture Experts Group (MPEG)-Transport Stream (TS) packet. In Miracast-R1, each MPEG-TS packet is 188 bytes long that carries 184 bytes of payload data. Security frameworks such a WPS, WEP, WPA, IPsec and HDCP are not possible to be applied in Miracast-R1 to the level of MPEG2-TS packets for conditional access of media streams belonging to different program identifiers (PID). For example, in Mircast-R1, WiFi-Security (e.g., WPS, WEP, WPA, etc.) is used for protecting Media Access Control (MAC) Service Data Units (MSDUs), IPSec is used for protecting IP packets and HDCP is used for protecting the media-data in the packetized elementary stream (PES) packet.

In terms of security, certain WiFi-Security protocols (e.g., WEP and 802.11i security manager) maintain session keys within a WiFi subsystem, and it is forbidden to expose or share security parameters (e.g., keys, contexts, etc.) outside of an associated security domain.

Further, the above-noted security frameworks (e.g., WPS, WEP, WPA, IPSec, HDCP, etc.) conventionally use pairwise security association. This is useful for one-to-one packet transfer, but pairwise security associations can be difficult to extend to one-to-many scenarios (e.g., broadcast or multicast). For example, a given Source device (such as an UE) that wants to transmit to N target Sink devices would need to establish a unique pairwise security association with each of the N target Sink devices, resulting in N total pairwise security associations. Hence, it is difficult to scale security frameworks that use pairwise security association for one-to-many media distribution schemes (e.g., multi-channel audio, multi-screen video, etc.).

Further, HDCP uses Digital Visual Interface (DVI) stream cipher. DVI stream cipher typically requires significant processing resources & power. Considering WiFi channel latency and packet-drop rates, deployment of DVI stream cipher may cause link termination which in turn requires lengthy link re-establishments. Also, DVI stream cipher is generally designed for XOR RGB pixel-data with PN-data, and is not typically used on MPEG-TS packets' level.

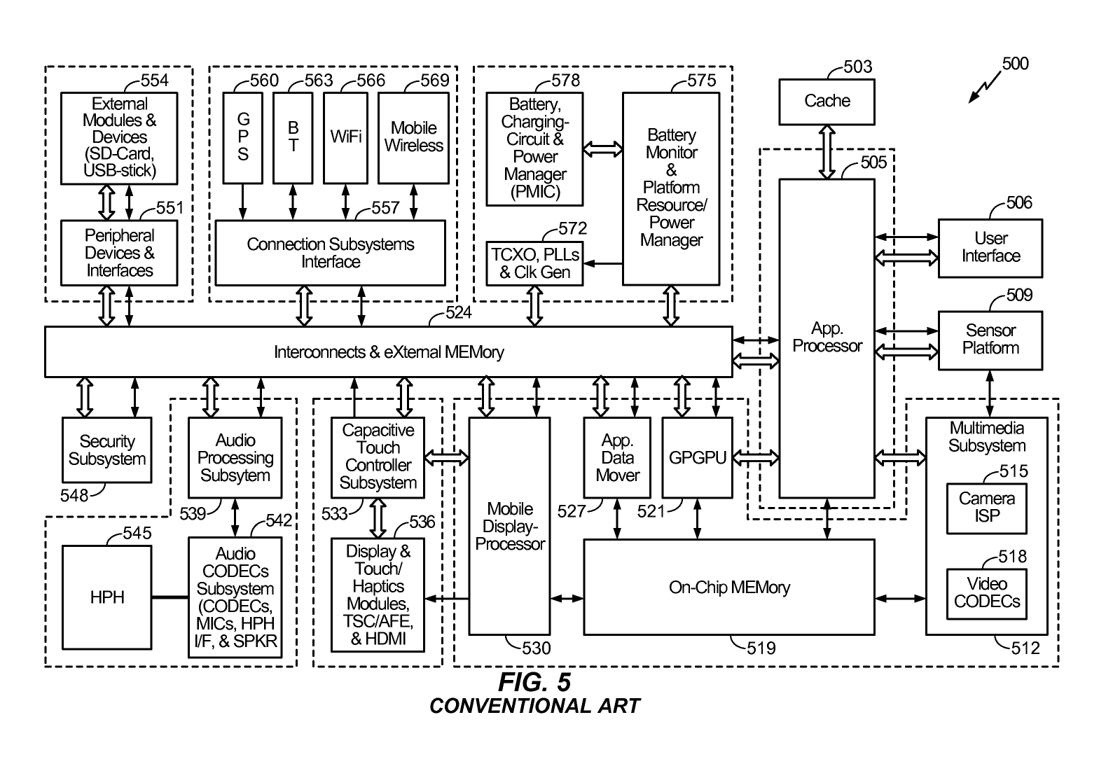

FIG. 5 illustrates a conventional UE configuration 500. Referring to FIG. 5, the conventional UE configuration 500 includes an application processor 505 that is coupled to a cache 503, a user interface 506, a sensor platform 509, a multimedia subsystem 512 that includes a camera ISP 515 and video codecs 518, on-chip memory 519, a general-purpose computing on graphics processing unit (GPGPU) 521, and a number of interconnects and external memory, 524. The conventional UE configuration 500 further includes an application data mover 527, mobile display processor 530, a capacitive touch controller subsystem 533, a display and touch haptics module 536 (e.g., TSC/AFE, HDMI, etc.), an audio processing subsystem 539, an audio codecs subsystem (e.g., CODECS, MICs, HPH I/F and SPKR) 542, an HDP 545 and a security subsystem 548. The interconnects and external memory 524 is coupled to peripheral devices and interfaces 551 which is in turn coupled to external modules and devices 554 (e.g., SD card, USB stick, etc.), connection subsystem interfaces 557 which are in turn coupled to a GPS module 560, a Bluetooth module 563, a WiFi module 566 and a mobile wireless module 569, TCXO, PLLs and clock generators 572, a bather monitor and platform resource power manager 575 which is in turn coupled to a battery charging circuit and power manager (PMIC) 578.

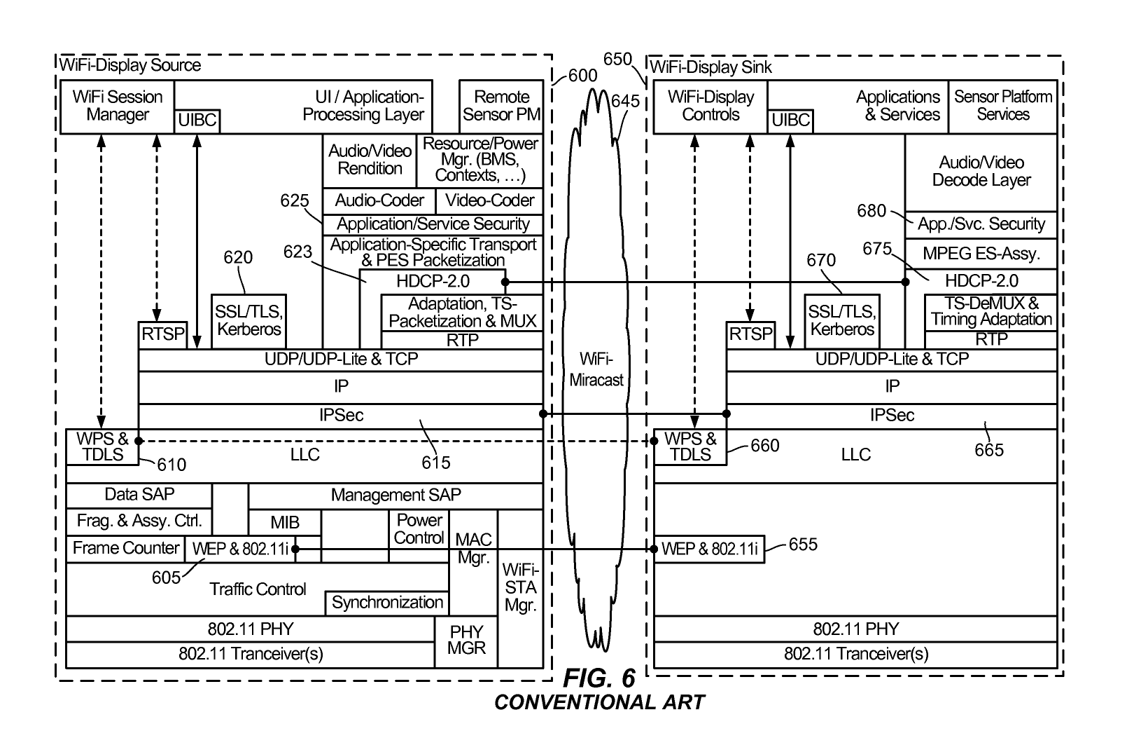

FIG. 6 illustrates a WiFi display source 600 (e.g., a UE configured as in FIG. 5) that is configured to send media to a WiFi display sink 650 (e.g., a television, an iPad, a set-top box, etc.) via a WiFi-Miracast link 645 using conventional security protocols. The WiFi display source 600 is provisioned with a number of components that facilitate communication with the WiFi display sink 650, including a WEP & 802.11i module 605, a WPS & TDLS module 610, an IPSec module 615, an SSL/TLS Kerberos module 620, an HDCP 2.0 module 623 and an application/service security module 625. The WiFi display source 600 also includes other well-known components (e.g., a traffic control module, a WiFi session manager, etc.). However, a further description of these well-known components is omitted for the sake of brevity so as to focus upon the components that are relevant to the embodiments of the invention.

Referring to FIG. 6, The WiFi display sink 650 is provisioned with a number of components that facilitate communication with the WiFi display source 600, including a WEP & 802.11i module 655, a WPS & TDLS module 660, an IPSec module 665, n SSL/TLS Kerberos module 670, an HDCP 2.0 module 675 and an application/service security module 680. The WiFi display sink 650 also includes other well-known components (e.g., a traffic control module, a WiFi session manager, etc.). However, a further description of these well-known components is omitted for the sake of brevity so as to focus upon the components that are relevant to the embodiments of the invention.

Referring to FIG. 6, various levels of point-to-point security can be implemented at different layers. For example, the WEP & 802.11i modules 605 and 655 can implement point-to-point security, the WPS & TDLS modules 610 and 660 can implement point-to-point security, the IPSec modules 615 and 665 can implement point-to-point security, the HDCP 2.0 modules 623 and 675, and so on. These various point-to-point security protocols (or frameworks) are well-known in the art. As noted above, these point-to-point security frameworks to not scale particularly well for one-to-many transmission scheme implementations. For example, the WEP & 802.11i module 605 would need to establish a different pairwise security association with corresponding WEP & 802.11i modules executing on each target device for a one-to-many transmission scheme implementation.

Embodiments of the invention are thereby directed to distributing encrypted, rendered media over a local wireless connection in accordance with a local wireless rendered media distribution scheme.

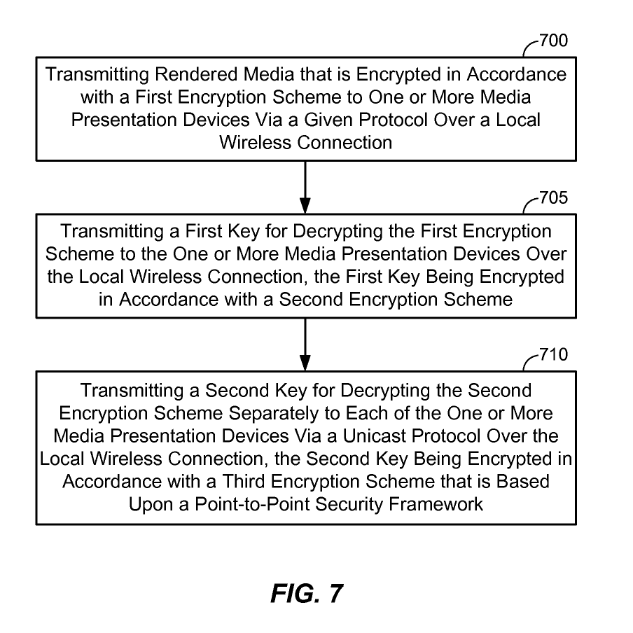

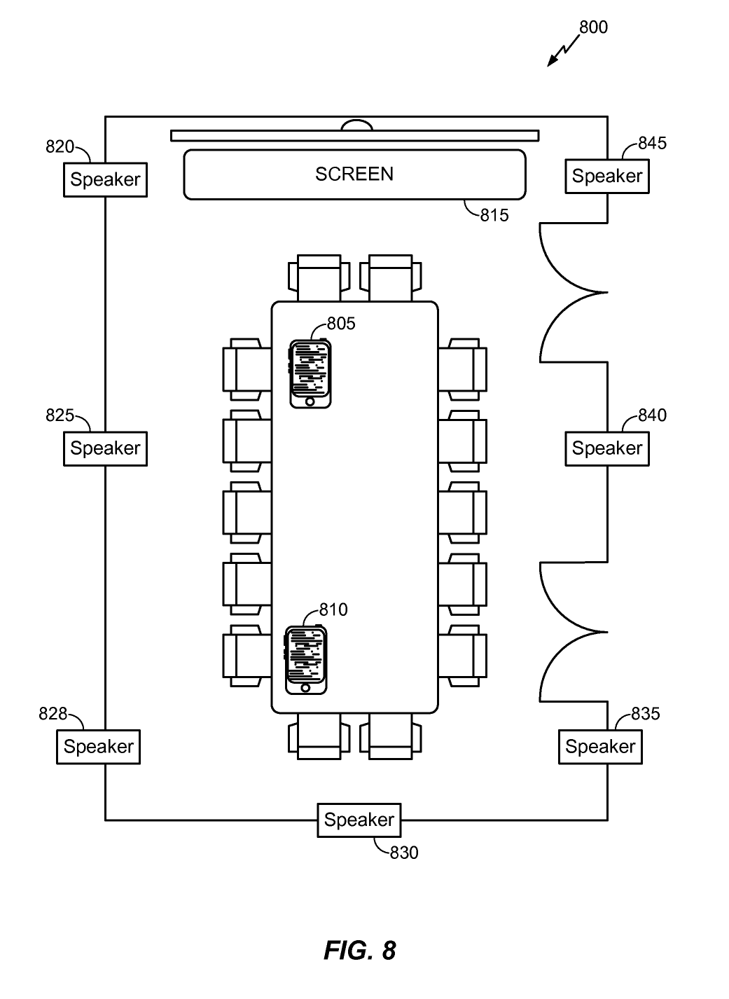

FIG. 7 illustrates a process of distributing rendered media over a local wireless connection (e.g., Miracast, etc.) in accordance with an embodiment of the invention. An example environment in which the process of FIG. 7 may operate is depicted in FIG. 8. In FIG. 8, a conference room 800 is depicted, which includes UE 805 (e.g., a phone, a tablet PC, etc.), UE 810 (e.g., a phone, a tablet PC, etc.), a display screen 815 and speakers 820-845. The operations described below with FIG. 7 are described in a particular order, but this order is not necessarily the order in which the various operations in the process of FIG. 7 occur (e.g., the first and/or second keys may be transmitted before the rendered media begins transmission if the first and/or second keys have not yet been handed out to any media presentation device, etc.).

Referring to FIG. 7, a media source transmits rendered media that is encrypted in accordance with a first encryption scheme to one or more media presentation devices via a given protocol (e.g., a broadcast protocol, a multicast protocol, a unicast protocol, etc.) over a local wireless connection, 700. For example, the media source may correspond to a UE, the first encryption scheme may be an application-layer encryption scheme or service encryption scheme (e.g., Advanced Encryption Standard (AES), MPEG-TS encryption, etc.), the one or more presentation devices may correspond to proximate audio and/or video playback devices (e.g., UE 810, display screen 815, speakers 820-845, etc.), the given protocol may be Moving Picture Experts Group (MPEG)-Transport Stream (TS) and the local wireless connection may be a WLAN-based infrastructure WiFi connection or a WiFi peer-to-peer wireless connection (e.g., WiFi Direct). In another example, if the given protocol corresponds to a unicast protocol, then the first encryption scheme may use point-to-point IP-layer encryption (e.g., IPSec, etc.), which provides more security relative to application-layer encryption schemes. In a more detailed example of 700 of FIG. 7 with respect to FIG. 8, the media source may correspond to UE 805, which transmits audio and video media to UE 810 (e.g., because UE 810 is relatively far away from the display screen 815 and concurrent display on UE 810 may help a user of UE 810 view the video content) and the display screen 815 for video playback, and to UEs 820-845 for audio playback.

Referring to FIG. 7, the media source transmits a first key for decrypting the first encryption scheme to the one or more media presentation devices over the local wireless connection, 705. The first key is encrypted in accordance with a second encryption scheme. The transmission of the first key at 705 may occur via either a broadcast or multicast protocol or via a unicast protocol. If the transmission of the first key at 705 occurs via the broadcast or multicast protocol (e.g., MPEG-TS, etc.), then the second encryption scheme may be the same as the first encryption scheme (e.g., AES, MPEG-TS encryption, etc.) that encrypts the rendered media at 700 (at least, when the given protocol also corresponds to the broadcast or multicast protocol). Alternatively, if the transmission of the first key at 705 occurs via the unicast protocol, then the second encryption scheme may use point-to-point IP-layer encryption (e.g., IPSec, etc.), which provides more security relative to application-layer encryption schemes.

Referring to FIG. 7, the media source transmits a second key for decrypting the second encryption scheme separately to each of the one or more media presentation devices via a unicast protocol over the local wireless connection, 710. The second key is encrypted in accordance with a third encryption scheme that is based upon a point-to-point security framework. For example, the third encryption scheme point-to-point IP-layer encryption (e.g., IPSec, etc.), which may also correspond to the second encryption scheme in some implementations (although the second encryption scheme could also use application-layer encryption as noted above).

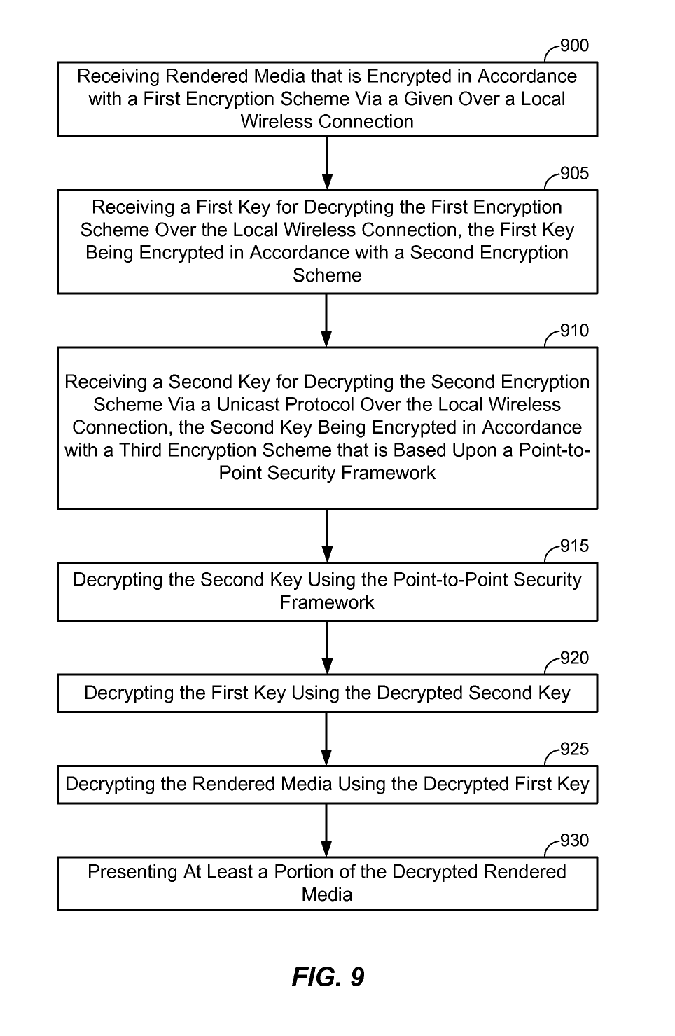

FIG. 9 illustrates operation of a given media presentation device during the process of FIG. 7 in accordance with an embodiment of the invention. In an example, the process of FIG. 9 may execute at each of the one or more media presentation devices as described with respect to FIG. 7, although not necessarily at the same time given that at least some of the transmissions from the media source to the one or more media presentation devices occur via unicast. The operations described below with FIG. 9 are described in a particular order, but this order is not necessarily the order in which the various operations in the process of FIG. 9 occur (e.g., the first and/or second keys may be received before the rendered media begins transmission if the first and/or second keys have not yet been handed out to any media presentation device, etc.).

Referring to FIG. 9, the given media presentation device receives the rendered media that is encrypted in accordance with the first encryption scheme via the given protocol (e.g., a broadcast protocol, a multicast protocol or a unicast protocol) over the local wireless connection, 900 (e.g., based on transmission from 700 of FIG. 7). The given media presentation device receives the first key for decrypting the first encryption scheme over the local wireless connection, with the first key being encrypted in accordance with the second encryption scheme, 905 (e.g., based on transmission from 705 of FIG. 7). The given media presentation device receives the second key for decrypting the second encryption scheme via the unicast protocol over the local wireless connection, with the second key being encrypted in accordance with the third encryption scheme, 910 (e.g., based on transmission from 710 of FIG. 7).

Referring to FIG. 9, the given media presentation device decrypts the second key received at 910 using the point-to-point security framework (e.g., IPSec, etc.) to obtain a decrypted second key, 915. The given media presentation device decrypts the first key received at 905 using the decrypted second key, 920. The given media presentation device decrypts the rendered media received at 900 using the decrypted first key, 925. The given media presentation device presents at least a portion of the decrypted rendered media (e.g., an audio portion, a video portion, both audio and video portions, etc.), 930. For example, if the given media presentation device corresponds to one of the speakers 820-845, the audio portion of the decrypted rendered media may be presented at 930. In another example, if the given media presentation device corresponds to UE 810 or the display screen 815, the video portion of the decrypted rendered media may be presented at 930 (and possibly the audio portion as well).

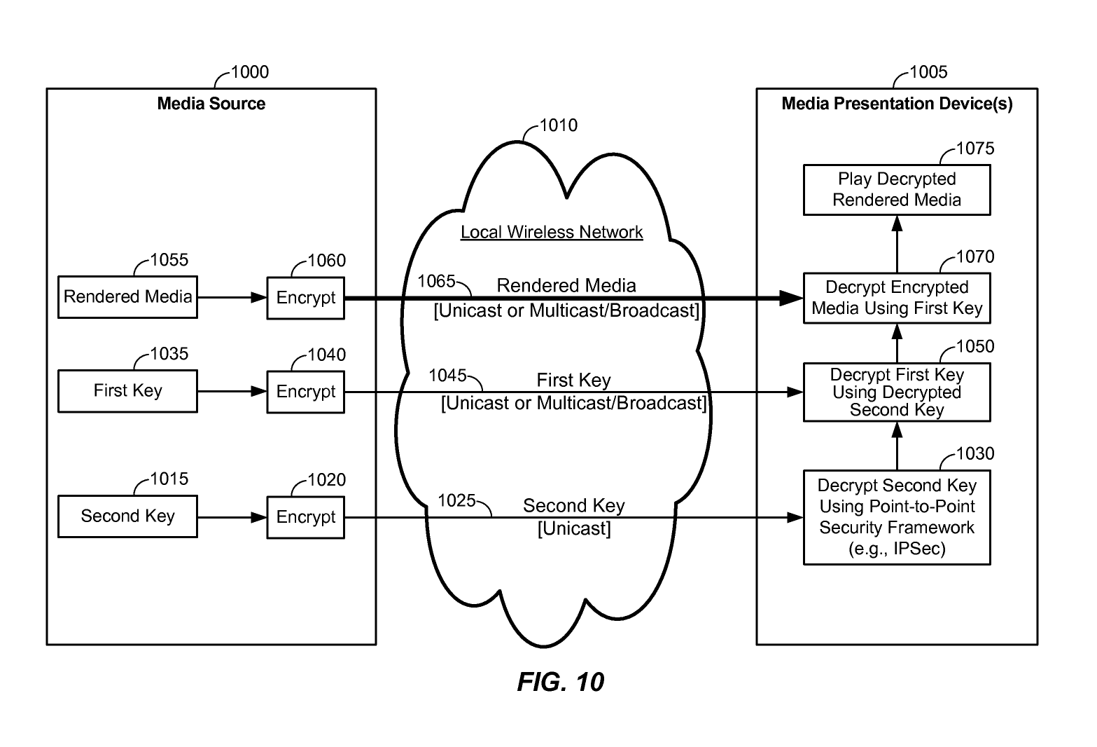

FIG. 10 illustrates the processes of FIGS. 7 and 9 being performed in unison in accordance with an embodiment of the invention. Referring to FIG. 10, a media source 1000 is connected to one or more media presentation devices 1005 over a local wireless network (e.g., WLAN, etc.). In other implementations, the media source 1000 may be connected to the one or more media presentation devices 1005 via a peer-to-peer connection, in which case the local wireless network 1005 may be bypassed. The media source 1000 generates the second key, 1015, encrypts the second key using the third encryption scheme (e.g., IPSec, etc.), 1020, and transmits the encrypted second key to each of the one or more media presentation devices 1005 via unicast over the local wireless network 1010, 1025 (e.g., as in 710 of FIG. 7 or 910 of FIG. 9). The one or more media presentation devices 1005 each decrypt the second key using the point-to-point security framework (e.g., IPSec, etc.), 1030 (e.g., as in 915 of FIG. 9), based on a pre-established pairwise security association between the one or more media presentation devices 1005 and the media source 1000.

The media source 1000 generates the first key, 1035, encrypts the first key using the second encryption scheme, 1040, and transmits the encrypted first key to each of the one or more media presentation devices 1005 over the local wireless network 1010, 1045 (e.g., as in 705 of FIG. 7 or 905 of FIG. 9). The one or more media presentation devices 1005 each decrypt the first key using the decrypted second key, 1050 (e.g., as in 920 of FIG. 9).

The media source 1000 generates the rendered media, 1055, encrypts the rendered media using the first encryption scheme, 1060, and transmits the encrypted rendered media to each of the one or more media presentation devices 1005 over the local wireless network 1010, 1065 (e.g., as in 700 of FIG. 7 or 900 of FIG. 9). The one or more media presentation devices 1005 each decrypt the rendered media using the decrypted first key, 1070 (e.g., as in 925 of FIG. 9), and then play at least a portion of the decrypted rendered media, 1075 (e.g., as in 930 of FIG. 9).

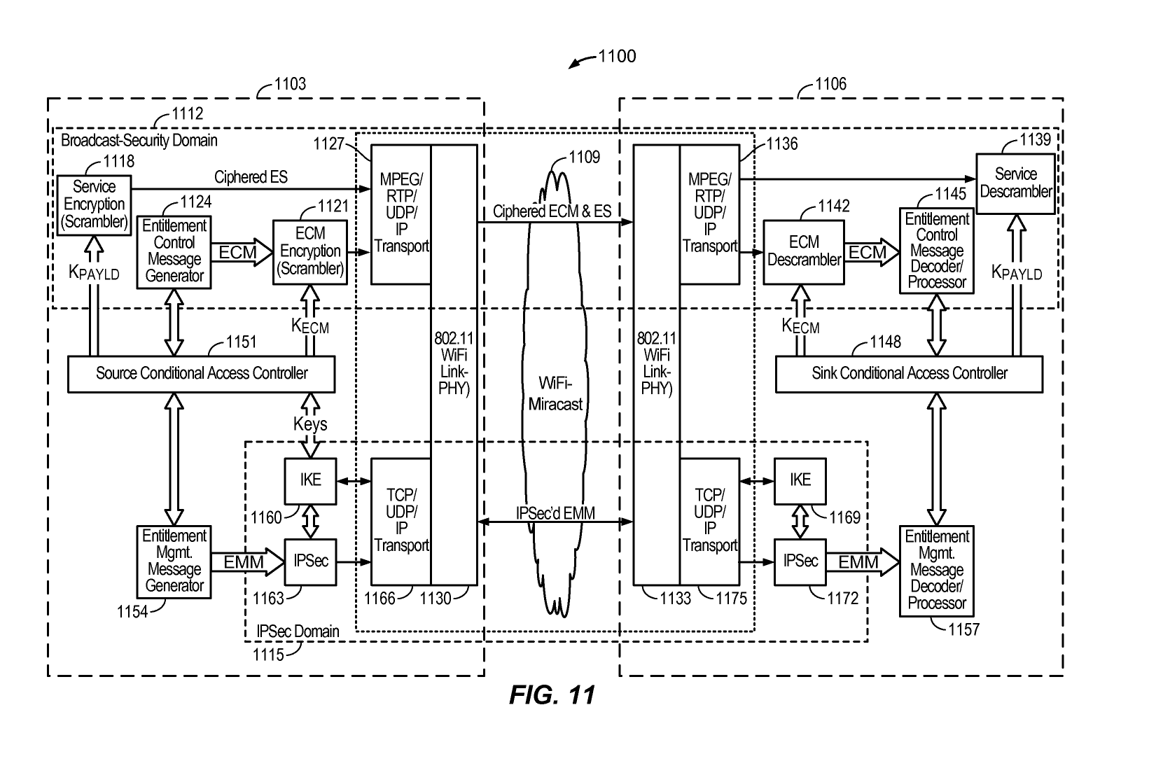

FIG. 11 illustrates an example of a Miracast-based system 1100 in accordance with an embodiment of the invention. Referring to FIG. 11, the Miracast-based system 1100 includes a media source 1103, a media presentation device (or media “sink”) 1106, and a WiFi-based Miracast network 1109. FIG. 11 depicts communicative operations related to security and encryption at different layers. In particular, FIG. 11 depicts a Broadcast Security Domain 1112 and a IPSec Domain 1115. The Broadcast Security Domain 1112 includes a Service Encryption (Scrambler) module 1118 configured to encrypt media via application-layer encryption (e.g., AES, MPEG-TS encryption, etc.) to generate an elementary stream (ES), which may correspond to the rendered media discussed above in other embodiments. The Broadcast Security Domain 1112 also includes an Entitlement Control Message (ECM) Encryption (Scrambler) module 1121 which receives an ECM from an ECM Generator 1124 and then encrypts the ECM via application-layer encryption (e.g., AES, MPEG-TS encryption, etc.).

Referring to FIG. 11, the encrypted ES and ECM are provided to an MPEG/RTP/UDP/IP Transport module 1127 which transmits the encrypted ES and ECMs via an 802.11/WIFI/Link-PHY module 1130 over the WiFi-based Miracast network 1109 to a corresponding 802.11/WIFI/Link-PHY module 1133 and MPEG/RTP/UDP/IP Transport module 1136 at the media presentation device 1106, which in turn routes the encrypted ES and ECM to a Service Descrambler module 1139 and an ECM Descrambler module 1142, respectively, for decryption. The ECM is decrypted at the ECM Descrambler 1142 based on an EMM (discussed below in more detail) and the decrypted ECM is then passed to an ECM Decoder/Processor 1145, which is in communication with a Sink Conditional Access Controller 1148. The decrypted ECM can then be used to decrypt the encrypted ES at the Service Descrambler 1139.

Referring to FIG. 11, the media source 1103 is further provisioned with a Source Conditional Access Controller 1151 and an Entitlement Management Message (EMM) Generator 1154. At the media presentation device 1106, an EMM Decoder/Processor 1157 is provisioned.

Referring to FIG. 11, the IPSec Domain 1115 includes, at the media source 1103, an Internet Key Exchange (IKE) module 1160, an IPSec module 1163 and a TCP/UDP/IP Transport module 1166. The IPSec Domain 1115 also has access to the 802.11/WIFI/Link-PHY module 1130 for transmissions to the media presentation device 1106. At the media presentation device 1106, an IKE module 1169, IPSec module 1172 and TCP/UDP/IP Transport module 1175 are provisioned. Accordingly, an EMM generated by EMM Generator 1154 is IPSec-encrypted at the media source 1103, transferred over to the media presentation device 1106 and IPSec-decrypted, and the decrypted EMM is then passed to EMM Decoder/Processor 1157. The EMM Decoder/Processor 1157 then passes the decrypted EMM to the ECM Descrambler 1142 to facilitate decryption of the ECM via the Sink Conditional Access Controller 1148.

While the embodiment of FIG. 11 relates to an implementation whereby the ECM is encrypted and decrypted using application-layer encryption at the Broadcast Security Domain 1112, in an alternative embodiment, the ECM may be encrypted and decrypted within the IPSec Domain 1115. So, the ECM can be conveyed from the media source 1103 to the media presentation device 1106 at the application-layer or (not shown) at the IP-layer.

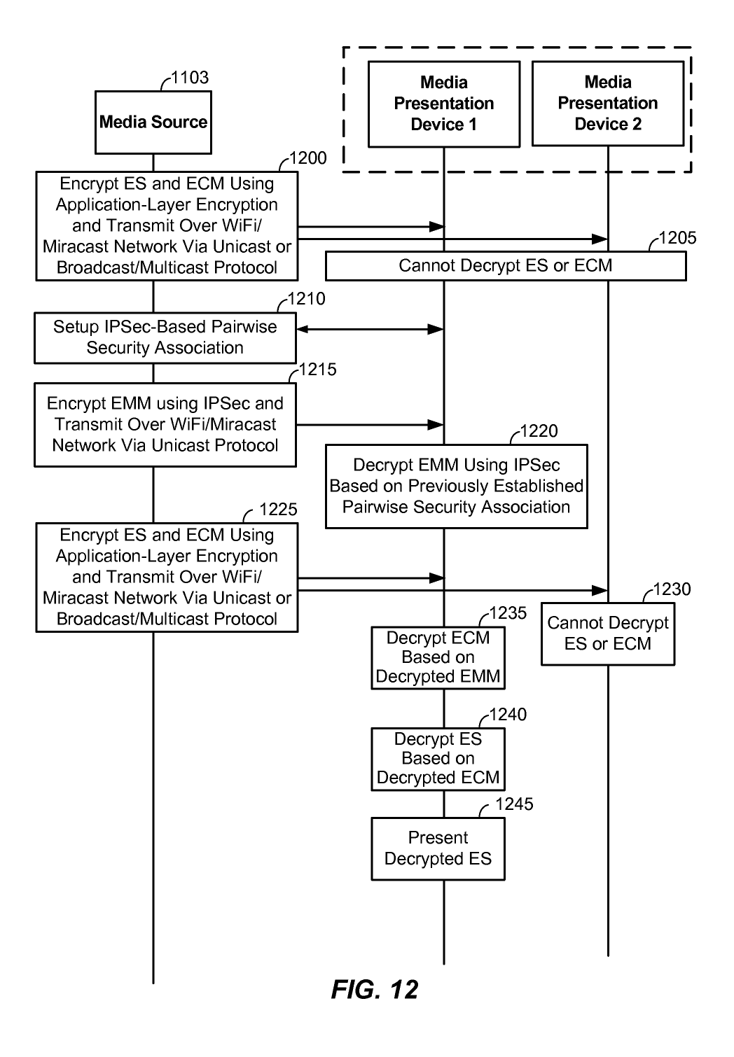

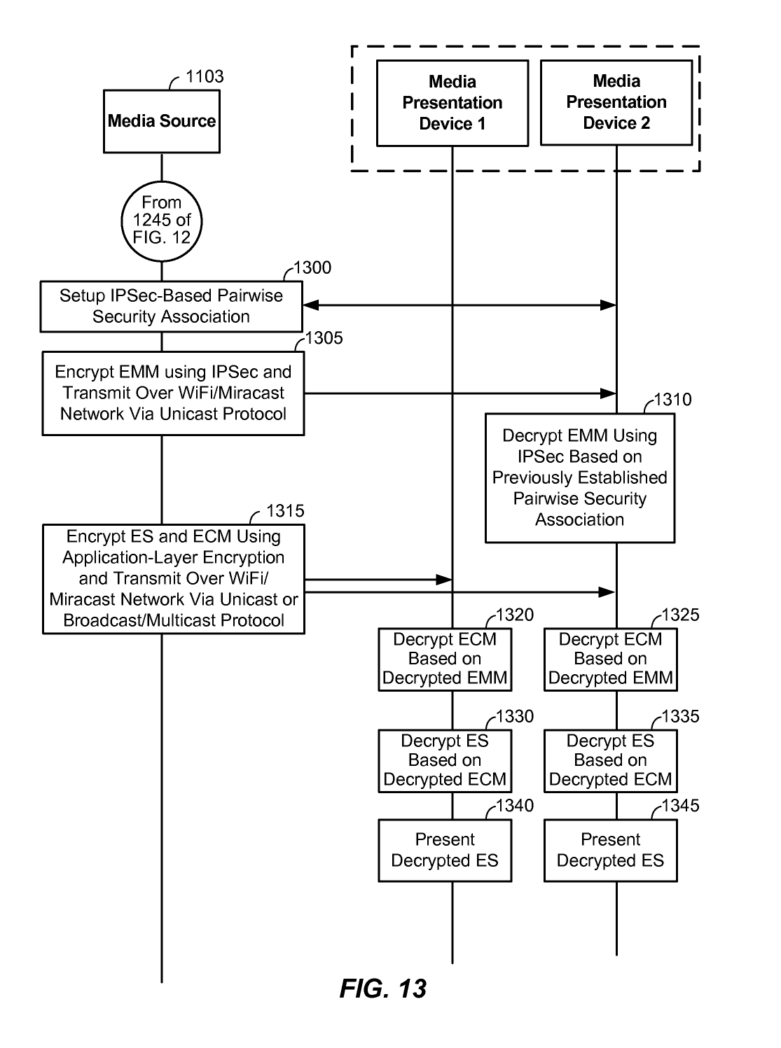

FIGS. 12-13 illustrate an example implementation of the processes of FIGS. 7 and 9 in the Miracast-based system 1100 of FIG. 11 in accordance with an embodiment of the invention.

Referring to FIG. 12, the media source 1103 encrypts the ES and ECM using application-layer encryption and then transmits the encrypted ES and ECM over the WiFi-based Miracast network 1109 via the given protocol (e.g., Miracast, which may use either a unicast protocol or a broadcast or multicast protocol), 1200. The operation of 1200 is handled at the Broadcast Security Domain 1112 depicted in FIG. 11. Media presentation devices 1 and 2 (which may each be configured as the media presentation device 1106 from FIG. 11) receive the encrypted ES and ECM, but cannot yet decrypt the ES or ECM because media presentation devices 1 and 2 do not yet have the EMM, 1205.

The media source 1103 sets up an IPSec-based pairwise security association with media presentation device 1, 1210. The media source 1103 encrypts the EMM using IPSec and then transmits the encrypted EMM over the WiFi-based Miracast network 1109 via a unicast protocol to media presentation device 1, 1215. Media presentation device 1 decrypts the EMM using IPSec based on the previously established pairwise security association from 1215. The operation of 1210-1220 is handled at the IPSec Domain 1115 depicted in FIG. 11.

At 1225, the media source 1103 continues to encrypt the ES and ECM using application-layer encryption and then transmits the encrypted ES and ECM over the WiFi-based Miracast network 1109 via the given protocol (e.g., Miracast, which may use either a unicast protocol or a broadcast or multicast protocol), 1225. Media presentation device 2 receives the encrypted ES and ECM, but cannot yet decrypt the ES or ECM because media presentation device 1 still does not yet have the EMM, 1230. However, media presentation device 1 is able to decrypt the ECM based on the decrypted EMM, 1235, and then to decrypt the ES based on the decrypted ECM, 1240, after which some or all of the decrypted ES is presented, 1245. The operation of 1225 and 1235-1245 is handled at the Broadcast Security Domain 1112 depicted in FIG. 11.

FIG. 13 illustrates a continuation of the process of FIG. 12 in accordance with an embodiment of the invention. After 1245 of FIG. 12, the media source 1103 sets up an IPSec-based pairwise security association with media presentation device 2, 1300. The media source 1103 encrypts the EMM using IPSec and then transmits the encrypted EMM over the WiFi-based Miracast network 1109 via a unicast protocol to media presentation device 2, 1305. Media presentation device 2 decrypts the EMM using IPSec based on the previously established pairwise security association from 1300. The operation of 1300-1310 is handled at the IPSec Domain 1115 depicted in FIG. 11.

At 1315, the media source 1103 continues to encrypt the ES and ECM using application-layer encryption and then transmits the encrypted ES and ECM over the WiFi-based Miracast network 1109 via the given protocol (e.g., Miracast, which may use either a unicast protocol or a broadcast or multicast protocol), 1315. Media presentation devices 1 and 2 each decrypt the ECM based on the decrypted EMM, 1320 and 1325, and each of media presentation devices decrypts the ES based on the decrypted ECM, 1330 and 1335, after which some or all of the decrypted ES is presented, 1340 and 1345. The operation of 1315-1345 is handled at the Broadcast Security Domain 1112 depicted in FIG. 11.

Accordingly, in certain embodiments of the invention, a higher-powered encryption protocol (e.g., IPSec) can be used to convey a relatively small key (e.g., EMM and possibly the ECM as well), which can ultimately facilitate encryption of bulk rendered media (e.g., ES) that is encrypted using a lower-powered encryption protocol (e.g., MPEG-TS encryption, AES, etc.) in a manner that is scalable as the number of target media presentation devices is increased. Further, while the embodiments described above at least in part with respect to Miracast, it will be appreciated that any local wireless media distribution scheme (e.g., WiFi Direct, LTE-D, Airplay, Chromecast, etc.) can be used in accordance with various embodiments of the invention.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of exchanging rendered media over a local wireless connection in accordance with a local wireless media distribution scheme, comprising:
transmitting rendered media that is encrypted in accordance with a first encryption scheme to one or more media presentation devices via a given protocol over a local wireless connection;
transmitting a first key for decrypting the first encryption scheme to the one or more media presentation devices over the local wireless connection, the first key being encrypted in accordance with a second encryption scheme; and
transmitting a second key for decrypting the second encryption scheme separately to each of the one or more media presentation devices via a unicast protocol over the local wireless connection, the second key being encrypted in accordance with a third encryption scheme that is based upon a point-to-point security framework.

2. The method of claim 1, wherein the first encryption scheme is an application-layer encryption scheme.

3. The method of claim 2, wherein the first encryption scheme includes Advanced Encryption Standard (AES), Moving Picture Experts Group (MPEG)-Transport Stream (TS) encryption, or any combination thereof.

4. The method of claim 1, wherein the local wireless media distribution scheme corresponds to Miracast.

5. The method of claim 1,
wherein the rendered media corresponds to an elementary stream (ES),
wherein the first key corresponds to an Entitlement Control Message (ECM), and
wherein the second key corresponds to an Entitlement Management Message (EMM).

6. The method of claim 1, wherein the second encryption scheme is an application-layer encryption scheme.

7. The method of claim 6, wherein the second encryption scheme includes Advanced Encryption Standard (AES), Moving Picture Experts Group (MPEG)-Transport Stream (TS) encryption, or any combination thereof.

8. The method of claim 1, wherein the second encryption scheme is an Internet Protocol (IP)-layer encryption scheme.

9. The method of claim 8, wherein the second encryption scheme includes IP Security (IPSec).

10. The method of claim 1, wherein the third encryption scheme is an Internet Protocol (IP)-layer encryption scheme.

11. The method of claim 10, wherein the third encryption scheme includes IP Security (IPSec).

12. The method of claim 1,
wherein the local wireless connection is over a local wireless network, or
wherein the local wireless connection is a peer-to-peer connection.

13. The method of claim 12,
wherein the local wireless network is an infrastructure Wireless Local Area Network (WLAN), and
wherein the peer-to-peer connection is WiFi-based.

14. The method of claim 1, wherein the given protocol corresponds to the unicast protocol, a broadcast protocol or a multicast protocol.

15. A method of exchanging rendered media over a local wireless connection in accordance with a local wireless media distribution scheme, comprising:
receiving rendered media that is encrypted in accordance with a first encryption scheme via a given protocol over the local wireless connection;
receiving a first key for decrypting the first encryption scheme over the local wireless connection, the first key being encrypted in accordance with a second encryption scheme;
receiving a second key for decrypting the second encryption scheme via a unicast protocol over the local wireless connection, the second key being encrypted in accordance with a third encryption scheme that is based upon a point-to-point security framework;
decrypting the second key using the point-to-point security framework;
decrypting the first key using the decrypted second key;
decrypting the rendered media using the decrypted first key; and
presenting at least a portion of the decrypted rendered media.

16. The method of claim 15, wherein the first encryption scheme is an application-layer encryption scheme.

17. The method of claim 16, wherein the first encryption scheme includes Advanced Encryption Standard (AES), Moving Picture Experts Group (MPEG)-Transport Stream (TS) encryption, or any combination thereof.

18. The method of claim 15, wherein the local wireless media distribution scheme corresponds to Miracast.

19. The method of claim 15,
wherein the rendered media corresponds to an elementary stream (ES),
wherein the first key corresponds to an Entitlement Control Message (ECM), and
wherein the second key corresponds to an Entitlement Management Message (EMM).

20. The method of claim 15, wherein the second encryption scheme is an application-layer encryption scheme.

21. The method of claim 20, wherein the first encryption scheme includes Advanced Encryption Standard (AES), Moving Picture Experts Group (MPEG)-Transport Stream (TS) encryption, or any combination thereof.

22. The method of claim 15, wherein the second encryption scheme is an Internet Protocol (IP)-layer encryption scheme.

23. The method of claim 22, wherein the second encryption scheme includes IP Security (IPSec).

24. The method of claim 15, wherein the third encryption scheme is an Internet Protocol (IP)-layer encryption scheme.

25. The method of claim 24, wherein the third encryption scheme includes IP Security (IPSec).

26. The method of claim 15,
wherein the local wireless connection is over a local wireless network, or
wherein the local wireless connection is a peer-to-peer connection.

27. The method of claim 26,
wherein the local wireless network is an infrastructure Wireless Local Area Network (WLAN), and
wherein the peer-to-peer connection is WiFi-based.

28. The method of claim 15,
wherein the decrypted rendered media includes audio and video, and
wherein the presenting presents the audio, the video or both.

29. The method of claim 15, wherein the given protocol corresponds to the unicast protocol, a broadcast protocol or a multicast protocol.

30. A media source configured to exchange rendered media over a local wireless connection in accordance with a local wireless media distribution scheme, comprising:
means for transmitting rendered media that is encrypted in accordance with a first encryption scheme to one or more media presentation devices via a given protocol over a local wireless connection;
means for transmitting a first key for decrypting the first encryption scheme to the one or more media presentation devices over the local wireless connection, the first key being encrypted in accordance with a second encryption scheme; and
means for transmitting a second key for decrypting the second encryption scheme separately to each of the one or more media presentation devices via a unicast protocol over the local wireless connection, the second key being encrypted in accordance with a third encryption scheme that is based upon a point-to-point security framework.

31. The media source of claim 30, wherein the first encryption scheme is an application-layer encryption scheme.

32. The media source of claim 30, wherein the local wireless media distribution scheme corresponds to Miracast.

33. The media source of claim 30,
wherein the rendered media corresponds to an elementary stream (ES),
wherein the first key corresponds to an Entitlement Control Message (ECM), and
wherein the second key corresponds to an Entitlement Management Message (EMM).

34. The media source of claim 30, wherein the second encryption scheme is an application-layer encryption scheme.

35. The media source of claim 30, wherein the second encryption scheme is an Internet Protocol (IP)-layer encryption scheme.

36. The media source of claim 30, wherein the third encryption scheme is an Internet Protocol (IP)-layer encryption scheme.

37. The media source of claim 30,
wherein the local wireless connection is over a local wireless network, or
wherein the local wireless connection is a peer-to-peer connection.

38. The media source of claim 30, wherein the given protocol corresponds to the unicast protocol, a broadcast protocol or a multicast protocol.

39. A media presentation device configured to exchange rendered media over a local wireless connection in accordance with a local wireless media distribution scheme, comprising:
means for receiving rendered media that is encrypted in accordance with a first encryption scheme via a given protocol over the local wireless connection;
means for receiving a first key for decrypting the first encryption scheme over the local wireless connection, the first key being encrypted in accordance with a second encryption scheme;
means for receiving a second key for decrypting the second encryption scheme via a unicast protocol over the local wireless connection, the second key being encrypted in accordance with a third encryption scheme that is based upon a point-to-point security framework;
means for decrypting the second key using the point-to-point security framework;
means for decrypting the first key using the decrypted second key;
means for decrypting the rendered media using the decrypted first key; and
means for presenting at least a portion of the decrypted rendered media.

40. The media presentation device of claim 39, wherein the first encryption scheme is an application-layer encryption scheme.

41. The media presentation device of claim 39, wherein the local wireless media distribution scheme corresponds to Miracast.

42. The media presentation device of claim 39,
wherein the rendered media corresponds to an elementary stream (ES),
wherein the first key corresponds to an Entitlement Control Message (ECM), and
wherein the second key corresponds to an Entitlement Management Message (EMM).

43. The media presentation device of claim 39, wherein the second encryption scheme is an application-layer encryption scheme.

44. The media presentation device of claim 39, wherein the second encryption scheme is an Internet Protocol (IP)-layer encryption scheme.

45. The media presentation device of claim 39, wherein the second encryption scheme includes IP Security (IPSec).

46. The media presentation device of claim 39, wherein the third encryption scheme is an Internet Protocol (IP)-layer encryption scheme.

47. The media presentation device of claim 39,
wherein the local wireless connection is over a local wireless network, or
wherein the local wireless connection is a peer-to-peer connection.

48. The media presentation device of claim 39,
wherein the decrypted rendered media includes audio and video, and
wherein the presenting presents the audio, the video or both.

49. The media presentation device of claim 39, wherein the given protocol corresponds to the unicast protocol, a broadcast protocol or a multicast protocol.

50. A media source configured to exchange rendered media over a local wireless connection in accordance with a local wireless media distribution scheme, comprising:
transceiver circuitry configured to transmit rendered media that is encrypted in accordance with a first encryption scheme to one or more media presentation devices via a given protocol over the local wireless connection, to transmit a first key for decrypting the first encryption scheme to the one or more media presentation devices over the local wireless connection, the first key being encrypted in accordance with a second encryption scheme and to transmit a second key for decrypting the second encryption scheme separately to each of the one or more media presentation devices via a unicast protocol over the local wireless connection, the second key being encrypted in accordance with a third encryption scheme that is based upon a point-to-point security framework.

51. The media source of claim 50, wherein the first encryption scheme is an application-layer encryption scheme.

52. The media source of claim 50, wherein the local wireless media distribution scheme corresponds to Miracast.

53. The media source of claim 50,
wherein the rendered media corresponds to an elementary stream (ES),
wherein the first key corresponds to an Entitlement Control Message (ECM), and
wherein the second key corresponds to an Entitlement Management Message (EMM).

54. The media source of claim 50, wherein the second encryption scheme is an application-layer encryption scheme.

55. The media source of claim 50, wherein the second encryption scheme is an Internet Protocol (IP)-layer encryption scheme.

56. The media source of claim 50, wherein the third encryption scheme is an Internet Protocol (IP)-layer encryption scheme.

57. The media source of claim 50,
wherein the local wireless connection is over a local wireless network, or
wherein the local wireless connection is a peer-to-peer connection.

58. The media source of claim 50, wherein the given protocol corresponds to the unicast protocol, a broadcast protocol or a multicast protocol.

59. A media presentation device configured to exchange rendered media over a local wireless connection in accordance with a local wireless media distribution scheme, comprising:
transceiver circuitry configured to receive rendered media that is encrypted in accordance with a first encryption scheme via a given protocol over the local wireless connection, to receive a first key for decrypting the first encryption scheme over the local wireless connection, the first key being encrypted in accordance with a second encryption scheme, and to receive a second key for decrypting the second encryption scheme via a unicast protocol over the local wireless connection, the second key being encrypted in accordance with a third encryption scheme that is based upon a point-to-point security framework;
at least one processor configured to decrypt the second key using the point-to-point security framework, to decrypt the first key using the decrypted second key, and to decrypt the rendered media using the decrypted first key; and
user interface output circuitry configured to present at least a portion of the decrypted rendered media.

60. The media presentation device of claim 59, wherein the first encryption scheme is an application-layer encryption scheme.

61. The media presentation device of claim 59, wherein the local wireless media distribution scheme corresponds to Miracast.

62. The media presentation device of claim 59,
wherein the rendered media corresponds to an elementary stream (ES),
wherein the first key corresponds to an Entitlement Control Message (ECM), and
wherein the second key corresponds to an Entitlement Management Message (EMM).

63. The media presentation device of claim 59, wherein the second encryption scheme is an application-layer encryption scheme.

64. The media presentation device of claim 59, wherein the second encryption scheme is an Internet Protocol (IP)-layer encryption scheme.

65. The media presentation device of claim 59, wherein the second encryption scheme includes IP Security (IPSec).

66. The media presentation device of claim 59, wherein the third encryption scheme is an Internet Protocol (IP)-layer encryption scheme.

67. The media presentation device of claim 59,
wherein the local wireless connection is over a local wireless network, or
wherein the local wireless connection is a peer-to-peer connection.

68. The media presentation device of claim 59,
wherein the decrypted rendered media includes audio and video, and
wherein the presenting presents the audio, the video or both.

69. The media presentation device of claim 59, wherein the given protocol corresponds to the unicast protocol, a broadcast protocol or a multicast protocol.

70. A non-transitory computer-readable medium containing instructions stored thereon, which, when executed by a media source configured to exchange rendered media over a local wireless connection in accordance with a local wireless media distribution scheme, cause the media source to perform operations, the instructions comprising:
at least one instruction to cause the media source to transmit rendered media that is encrypted in accordance with a first encryption scheme to one or more media presentation devices via a given protocol over a local wireless connection;
at least one instruction to cause the media source to transmit a first key for decrypting the first encryption scheme to the one or more media presentation devices over the local wireless connection, the first key being encrypted in accordance with a second encryption scheme; and
at least one instruction to cause the media source to transmit a second key for decrypting the second encryption scheme separately to each of the one or more media presentation devices via a unicast protocol over the local wireless connection, the second key being encrypted in accordance with a third encryption scheme that is based upon a point-to-point security framework.

71. The non-transitory computer-readable medium of claim 70, wherein the first encryption scheme is an application-layer encryption scheme.

72. The non-transitory computer-readable medium of claim 70, wherein the local wireless media distribution scheme corresponds to Miracast.

73. The non-transitory computer-readable medium of claim 70,
wherein the rendered media corresponds to an elementary stream (ES),
wherein the first key corresponds to an Entitlement Control Message (ECM), and
wherein the second key corresponds to an Entitlement Management Message (EMM).

74. The non-transitory computer-readable medium of claim 70, wherein the second encryption scheme is an application-layer encryption scheme.

75. The non-transitory computer-readable medium of claim 70, wherein the second encryption scheme is an Internet Protocol (IP)-layer encryption scheme.

76. The non-transitory computer-readable medium of claim 70, wherein the third encryption scheme is an Internet Protocol (IP)-layer encryption scheme.

77. The non-transitory computer-readable medium of claim 70,
wherein the local wireless connection is over a local wireless network, or
wherein the local wireless connection is a peer-to-peer connection.

78. The non-transitory computer-readable medium of claim 70, wherein the given protocol corresponds to the unicast protocol, a broadcast protocol or a multicast protocol.

79. A non-transitory computer-readable medium containing instructions stored thereon, which, when executed by a media presentation device configured to exchange rendered media over a local wireless connection in accordance with a local wireless media distribution scheme, cause the media presentation device to perform operations, the instructions comprising:
at least one instruction to cause the media presentation device to receive rendered media that is encrypted in accordance with a first encryption scheme via a given protocol over a local wireless connection;
at least one instruction to cause the media presentation device to receive a first key for decrypting the first encryption scheme over the local wireless connection, the first key being encrypted in accordance with a second encryption scheme;
at least one instruction to cause the media presentation device to receive a second key for decrypting the second encryption scheme via a unicast protocol over the local wireless connection, the second key being encrypted in accordance with a third encryption scheme that is based upon a point-to-point security framework;
at least one instruction to cause the media presentation device to decrypt the second key using the point-to-point security framework;
at least one instruction to cause the media presentation device to decrypt the first key using the decrypted second key;
at least one instruction to cause the media presentation device to decrypt the rendered media using the decrypted first key; and
at least one instruction to cause the media presentation device to present at least a portion of the decrypted rendered media.

80. The non-transitory computer-readable medium of claim 79, wherein the first encryption scheme is an application-layer encryption scheme.

81. The non-transitory computer-readable medium of claim 79, wherein the local wireless media distribution scheme corresponds to Miracast.

82. The non-transitory computer-readable medium of claim 79,
wherein the rendered media corresponds to an elementary stream (ES),
wherein the first key corresponds to an Entitlement Control Message (ECM), and
wherein the second key corresponds to an Entitlement Management Message (EMM).

83. The non-transitory computer-readable medium of claim 79, wherein the second encryption scheme is an application-layer encryption scheme.

84. The non-transitory computer-readable medium of claim 79, wherein the second encryption scheme is an Internet Protocol (IP)-layer encryption scheme.

85. The non-transitory computer-readable medium of claim 79, wherein the second encryption scheme includes IP Security (IPSec).

86. The non-transitory computer-readable medium of claim 79, wherein the third encryption scheme is an Internet Protocol (IP)-layer encryption scheme.

87. The non-transitory computer-readable medium of claim 79,
wherein the local wireless connection is over a local wireless network, or
wherein the local wireless connection is a peer-to-peer connection.

88. The non-transitory computer-readable medium of claim 79,
wherein the decrypted rendered media includes audio and video, and
wherein the presenting presents the audio, the video or both.

89. The non-transitory computer-readable medium of claim 79, wherein the given protocol corresponds to the unicast protocol, a broadcast protocol or a multicast protocol.
